(19) United States
(12) Patent Application Publication
(10) Pub. No.: US 2008/0273441 A1
(43) Pub. Date: Nov. 6, 2008

(54) Optical Data Storage Medium and Combi-Foil Cover for the Production Thereof

(75) Inventors: Leendert Van Der Tempel, Eindhoven (NL); Hermanus Johannes Borg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,779

(22) PCT Filed: Jun. 24, 2005
(86) PCT No.: PCT/IB05/52086

§ 371 Date: Dec. 18, 2006

(30) Foreign Application Priority Data
Jun. 28, 2004 (EP) 04102996.8

(51) Int. Cl. G11B 3/74; B65D 85/57

(52) U.S. Cl. 369/94; 206/308.1

(57) ABSTRACT

An optical data storage medium is described comprising at least: —a synthetic resinous substrate, having a first side and a second opposite side, —a first layer stack comprising: a data storage layer stack formed on the first side of the substrate, a transparent cover stack formed on the data storage layer stack, the data storage layer stack being readable through the cover stack by means of a focused radiation beam. A second layer stack having a permeablity for moisture <0.5 g/m²/day, is applied to the second (non entry) side of the substrate. In this way the medium exhibits little or no, warpage under the influence of moisture. Further a roll-to-roll producible combi-foil is described. It comprises a polymer foil, in particular polycarbonate (PC), and a pressure sensitive adhesive (PSA) layer attached to one side of the polymer foil characterized in that the surface of the other side of the polymer foil has a relatively low surface energy in order to achieve sufficient release of the PSA when rolled out combined with anti-finger print functionality in use. A relatively cheap roll-to-roll combi-foil, e.g. for the production of an optical data storage medium of the type described above, is achieved.

The invention relates to an optical data storage medium comprising at least:

a synthetic resinous substrate, having a first side and a second opposite side,

a first layer stack comprising: a data storage layer stack formed on the first side of the substrate, a transparent cover layer formed on the data storage layer stack, the data storage layer stack being readable through the cover layer by means of a focused radiation beam.

The invention further relates to a combi-foil cover layer for the production of such an optical data storage medium. Combi-foil means a multi-layer cover foil, comprising at least a (polymer) foil and a Pressure Sensitive Adhesive (PSA).

Optical storage media are known per se, in particular from, for example, U.S. Pat. Nos. 5,490,131 and 6,051,298. A compact disc (hereinafter referred to as CD), a digital versatile disc (hereinafter referred to as a DVD) and a Blu-ray Disc (BD) are examples of an optical disc which can be considered to be a customary optical information medium. The latter (BD) is of the type as described in the opening paragraph. For BD a data storage layer stack is formed on the approximately 1.1 mm thick substrate of the disc, a cover stack being provided on the data storage layer stack in a thickness of approximately 100 micrometers. The data storage layer stack may include multiple recording layers in which case the cover layer may have a different, e.g. lower, thickness. The data storage layer stack is substantially impermeable for moisture. The BD medium is read-out through the cover stack which therefore has to be of good optical quality. Note that the cover stack may comprise one or more layers, e.g. a single spin coated layer or a resinous foil bonded by a pressure sensitive adhesive (PSA) layer or by a (spin coated and UV cured) lacquer layer. The read only version of the BD has information pits formed in the substrate covered by a reflective layer in which case the data storage layer stack simply comprises the reflective layer, e.g. a metal. The write-once and rewritable versions of the BD do not have pits but a continuous pregroove and the information is stored by locally changing the optical properties of a data storage layer of the data storage layer stack, e.g. a dye or a metal alloy by means of a modulated focused radiation beam. It is to be noted that the term “data storage layer stack” used in the opening paragraph does not only comprise a single layer but also a so-called stack or packet of such layers, for example, in case of a rewritable medium, of metal, ZnS—SiO₂, phase-change material, e.g. a metal alloy, and ZnS—SiO₂. In the opening paragraph, such a stack or layer packet is also to be considered to be impermeable.

The method of manufacturing optical discs is known per se and employs certain processes, such as (compression)-injection molding, photopolymerization, and the like, the disc-shaped substrate generally being made from polycarbonate. The reflective layer covering the pits or lands and grooves in the disc-shaped substrate is obtained by means of, for example, vacuum evaporation or sputtering, and is customarily made from aluminum or silver (alloys) or other metal alloys. In case of the read-only BD the cover stack serving as a read out and protective layer is applied to the data storage layer stack, including a metal layer, e.g. aluminum, in order to protect this thin metal layer against damage that may result from general physical contact. As indicated above this cover stack is generally provided by means of a pre-fabricated cover foil with a PSA or spin coated and UV cured lacquer or entirely by means of a spin-coating process spin coated and UV cured lacquer. Such optical discs are generally employed in an environment where the atmospheric relative humidity is subject to variation. E.g. for polycarbonate, the water vapor or moisture present in the ambient air sorbs into/desorbs from the synthetic resinous substrate and cover and, as a result of the fluctuation of the relative humidity in the surrounding atmosphere. As a result of the presence of the impermeable metal layer, exchange of moisture between the protective film and the synthetic resin substrate will hardly take place. Instead, moisture can only sorb into or desorb from the polymer-air interfaces.

Moisture uptake swells polymers. Sorption and desorption of moisture lead to water concentration gradients in the polymers, thereby causing swell gradients of the substrate and cover, causing warpage of the disc and especially if the impermeable metallization layer is axially eccentric. The basic shape of such warpage (by bending moments) is spherical or umbrella shape, that is blunt by the clamping. Undue (out of spec) radial deviation of the disc is undesirable. Undue radial deviation may lead to uncorrectable read/write errors caused by disturbance of the laser beam intensity profile. Several solutions to reduce undue radial deviation or disc warpage have been proposed. In U.S. Pat. No. 5,490,131 axial symmetry has been proposed. For the BD disc this could mean that a copy of the first layer stack is provided symmetrically on the second side of the substrate. This is not always satisfactory in case of an all-lacquer cover and a relatively expensive solution in case of a cover foil since the cover foil or sheet is relatively expensive. Furthermore deposition of the second metal layer and the bonding application of the second cover adds production time and lowers the production yield.

Combi-foils are also known per se. Usually they have a multi-layer structure consisting of 4 layers:

disposable anti-scratch liner or anti-scratch (AS) coating

polymer (usually polycarbonate) foil

PSA

disposible release liner

The disposible liners protect against contamination but have four disadvantages:
additional cost
waste
shrinkage of the liner between application and peeling off causes stress relaxation after bonding, resulting in disk warpage
surface topography of the anti-scratch liner affects the surface topography of the cover

Additional anti-fingerprint, anti-static and lubricant coatings are also known from e.g. Naoki Hayashida e.a., High-performance hard coat for cartridge-free Blu-ray Disc, Japanese Journal Applied Physics, 42, pp. 750-753, 2003.

It is a first object of the invention to provide an optical data storage medium of the type mentioned in the opening paragraph, which exhibits little or no, warpage under the influence of moisture.

It is a second object of the invention to provide a relatively cheap roll-to-roll producable combi-foil, e.g. for the production of an optical data storage medium of the type mentioned in the opening paragraph.

The first object is achieved with the optical data storage medium, in accordance with a first aspect of the invention, which is characterized in that a second layer stack, having a permeablity for moisture <0.5 g/m²/day, is applied to the second (non entry) side of the substrate. Preferably the permeablity for moisture is <0.2 g/m²/day.

Applicants have had the insight that axial symmetry is not required and that the important parameter is controlling the permeability for moisture, i.e. water. The proposed level limit of 0.5 g/m²/day is approximately 25% of the 1.77 g/m²/day calculated moisture absorption by a BD with a polycarbonate (PC) substrate in 24 hours at room temperature after a 50% relative ambient humidity step. Standard permeability tests can detect >0.001 g/m²/day, but moisture absorption may also be measured simply by weighing after a relative ambient humidity step.

In addition as discussed above, it is possible that, in certain embodiments, the optical data storage medium or optical disc comprises a data storage layer stack including two readable data storage layers, which are separated from each other by a so-called spacer layer. It will be clear that such an embodiment falls under the scope of protection of the invention, wherein these data storage layers are to be considered to be a composite data storage layer stack.

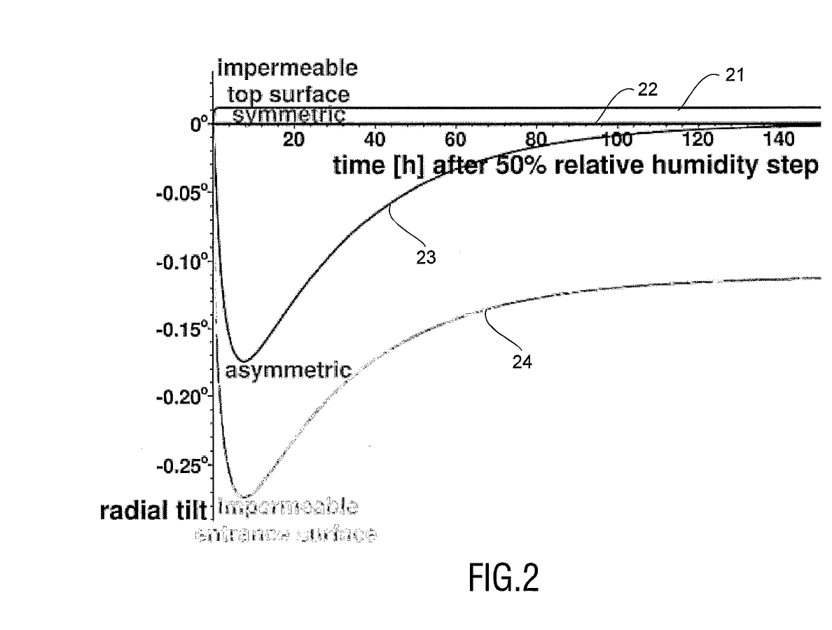

In an embodiment of the optical data storage medium the second layer stack comprises a metal layer nearest to the substrate and a protective layer most remote from the substrate. Applicants have had the insight that a metal layer, substantially opaque to the radiation beam, may be effectively used as a moisture barrier because the medium is read-out through the cover layer. This is preferably a CD type top finish, including a metal layer and a ˜5-10 μm protective lacquer coating, and can be applied at very low cost, e.g. at about 1% of the cost of full axial symmetry in case of a solvent cast cover foil. The advantage is that this process is well known and developed from the CD manufacturing process and has a high yield. A CD top finish reduces the warpage due to ambient relative humidity variations very effectively (FIG. 2). The warpage due to volume relaxation asymmetry can be reduced by additional low cost measures, such as a slowly creeping cover as described below.

Preferably the metal layer comprises one of aluminum, an aluminum alloy, silver and a silver alloy. Preferably the protective layer is a UV-cured acrylate. E.g. a practically impermeable aluminum layer having a thickness of e.g. 50 nm with a spin coated e.g. 5-10 μm thin UV-cured acrylate on top. The spin coated protection layer serves as a protection layer for the underlying metal layer. Preferably the resinous substrate comprises one of polycarbonate (PC) and poly(methyl methacrylate) (PMMA).

When the medium is one of a read only Blu-Ray Disc (BD), a write-once BD and a rewritable BD the invention is applicable since such media have a cover layer of about 100 μm and are read out through the cover layer.

It is to be noted that the invention can also be applied to e.g. flat polymer displays comprising several layers of polymers and moisture barriers. These displays may suffer from similar warpage problems.

The second object of the invention is achieved with a combi-foil suitable for roll-to-roll production comprising a polymer foil, in particular polycarbonate (PC), and a pressure sensitive adhesive (PSA) layer attached to one side of the polymer foil characterized in that the surface of the other side of the polymer foil has a relatively low surface energy in order to allow sufficient, i.e easy and smooth, release of the PSA when rolled out. In this way a (disposable) release liner can be omitted advantageously if the release function of the liner is combined with an anti-fingerprint (AF) function, i.e. relatively low surface energy, into a combined anti-fingerprint/release coating on the foil. The obvious method of application of such a coating is in a reel-to-reel process, e.g. by Physical Vapor Deposition (PVD). The foil is e.g. made of polycarbonate. Further the foil may have an anti-scratch coating and/or an anti-static coating and/or a lubricant. AS, AF and release functions may be integrated into one coating, alternatively the AF coating may reside on top of the AS coating.

In an advantageous embodiment an optical data storage medium of the type as described in the opening paragraph is characterized in that the transparent cover stack comprises such a combi foil.

The release liner of combifoils of polycarbonate with pressure sensitive adhesive for Blu-ray Discs (BD) covers can be omitted if the polycarbonate has a top coating combining anti-fingerprint with release properties.

BDs can be produced in three ways:

With a spin coated and UV-cured lacquer cover

With a polymer, usually polycarbonate, foil bonded to the sputtered substrate by spin coated and UV-cured lacquer

With a combi-foil, a polymer, usually polycarbonate, carrier foil with pressure sensitive adhesive (PSA). This invention relates to a roll-to-roll producible combi-foil for the latter method of production for BDs.

Preferred embodiments of the invention will now be described with reference to the drawings in which:

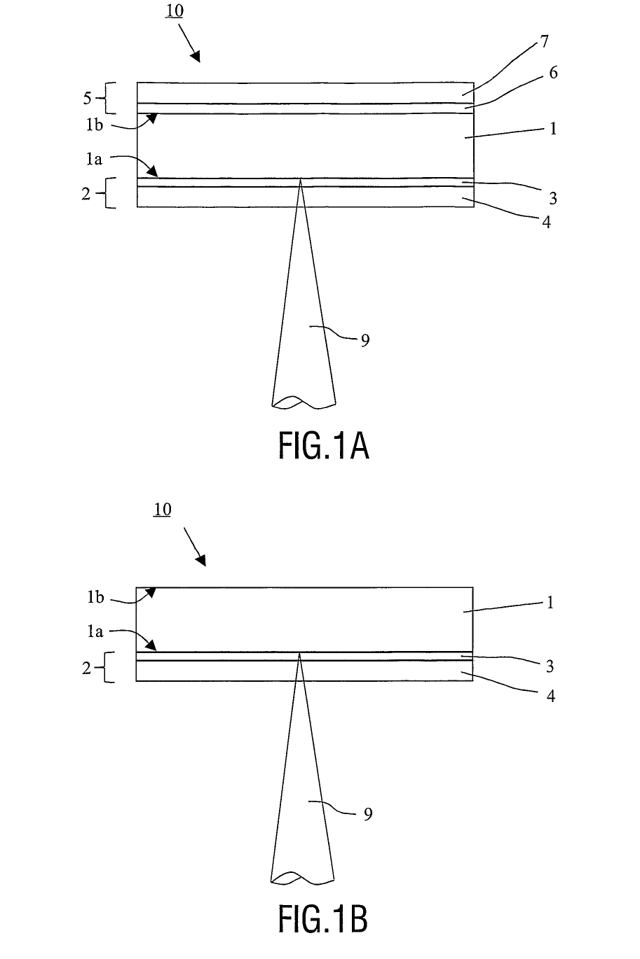

FIG. 1A shows a schematic cross sectional view of an optical data storage medium according to a first aspect of the invention,

FIG. 1B shows a schematic cross sectional view of an optical data storage medium according to a second aspect of the invention,

FIG. 2 shows the radial tilt as a function of time of a data storage medium according to the invention (impermeable top surface) compared to three other data storage media (not according to the invention).

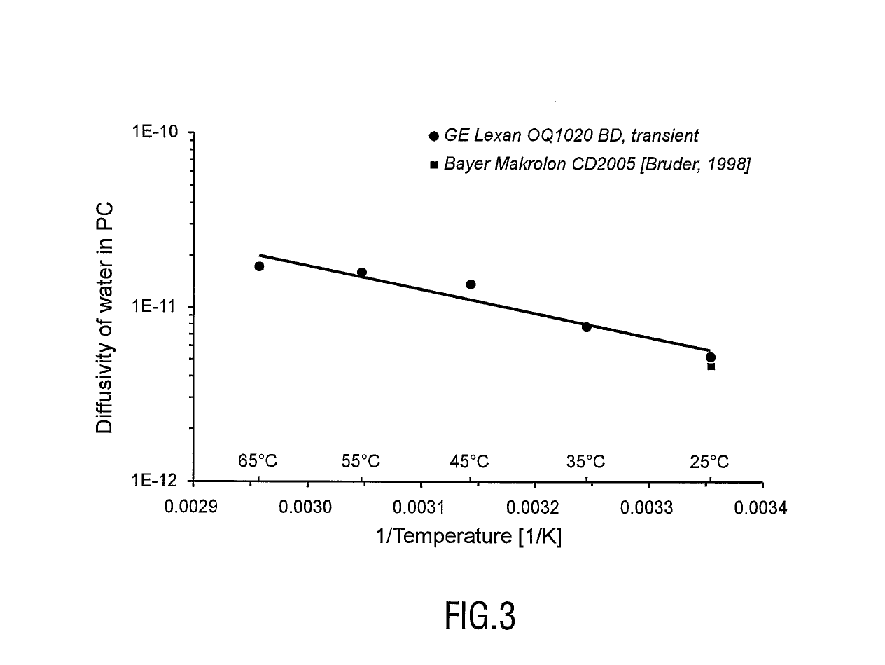

FIG. 3 shows the diffusivity of water in polycarbonate (PC) as a function of the inverse absolute temperature (1/K) for two different grades of PC.

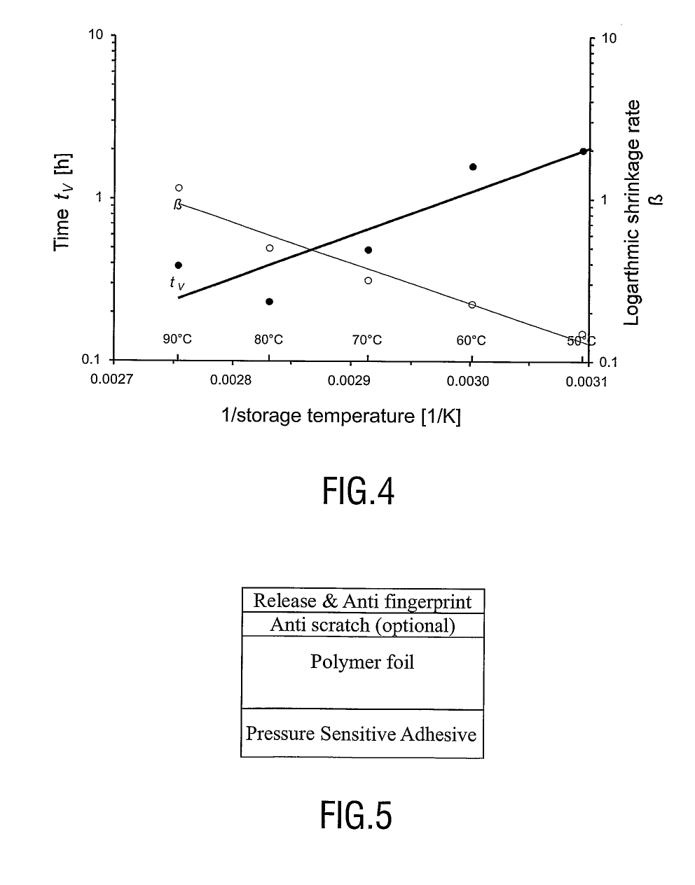

FIG. 4 schematically shows a cross-section of a roll-to-roll producible combi-foil according to the invention.

The invention will be explained hereinafter by means of examples. It is to be noted, however, that the invention is not limited to such a specific example and is limited only by the scope of protection of the annexed claims.

In FIG. 1A an optical data storage medium 10 is shown. The medium comprises a synthetic resinous substrate 1 made of polycarbonate having a first side 1a and a second opposite side 1b. A first layer stack 2 is formed on the first side 1a of the substrate 1. The first layer stack 2 comprises a data storage layer stack 3, and a transparent cover stack 4 formed on the data storage layer stack. The data storage layer stack is readable through the cover stack by means of a focused radiation beam 9. A second layer stack 5 is formed on the second side 1b of the substrate stack and has a permeablity for moisture <0.2 g/m²/day. The second layer stack comprises a metal layer 6 made of aluminum having a thickness in the range 40-130 nm and a protective layer 7 made of a UV-cured acrylate, e.g. Dainippon SD318, with a thickness of 10 μm. The protective layer may e.g. be applied by means of spin coating. The medium is e.g. one of a read only Blu-Ray Disc (BD), a write-once BD and a rewritable BD.

In FIG. 1B an embodiment of a second aspect of the invention is shown. At least one layer of the cover stack 4 has a characteristic retardation time t_{R} that is longer than the characteristic moisture absorption time t_{A} of the optical data storage medium comprising a substrate 1 made of e.g. polycarbonate. The characteristic moisture absorption time t_{A} (when the optical data storage medium is returned within e.g. 1% to its original radial deviation) decreases from about 124 h at room temperature down to about 21 h at 80° C. for a BD with GE Lexan OQ1020 substrate. The characteristic volumetric relaxation time t_{V} of the resinous substrate is between about 1 and 100 hours depending on the temperature, the polycarbonate grade and the processing conditions. The cover stack comprises a polymer with an average molar weight small enough in order to allow that t_{R} fulfils the following condition: t_{V}>t_{R}>t_{A}. E.g. a PSA met lower molecular weight and/or less branching

In FIG. 2 the radial tilt as a function of time of a data storage medium according to the invention (impermeable top surface) compared to three other data storage media geometries (not according to the invention) is shown. Curve 21 shows the radial tilt according to the invention when a metal layer 6 is present (substantially impermeable top surface). Curve 22 shows the radial tilt of a perfectly symmetric medium, an expensive solution. Curve 23 shows the radial tilt of an asymmetric medium, a standard BD geometry with layers 1, 3 and 4. Curve 24 shows the radial tilt of a BD with layers 1, 3 and 4 and with an additional thin impermeable coating at the laser entrance side on top of cover layer 4.

In FIG. 3 the diffusivity of water in polycarbonate (PC) as a function of the inverse absolute temperature (1/K) for two different grades of PC is shown. The water sorption time scale t_{A}=ck_{PC}/d² can be calculated from the diffusivity k_{PC} from diffusion theory, like in [Leendert van der Tempel, Deformation of polycarbonate optical disks by water sorption and ageing, Chapter accepted for Precision Injection Molding, Hanser Verlag] and [Friedrich Bruder & Wilfried Häse, Water absorption and transient tilt of polymeric substrates for optical data storage media, Japanese Journal of Applied Physics I, Vol. 38, pp. 1709-1710, 1999].

In FIG. 4 a roll-to-roll producible combi-foil according to the invention is shown schematically. From the laser entry side to the stack it shows the release & anti-fingerprint coating, an optional anti-scratch coating, the polymer foil and the PSA.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. An optical data storage medium (10) comprising at least:
a synthetic resinous substrate (1), having a first side (1a) and a second, opposite side (1b),
a first layer stack (2) comprising: a data storage layer stack (3) formed on the first side of the substrate, a transparent cover stack (4) formed on the data storage layer stack, the data storage layer stack being readable through the cover stack by means of a focused radiation beam (9), characterized in that
a second layer stack (5) having a permeablity for moisture <0.5 g/m²/day, is applied to the second, opposite side of the substrate.

2. An optical data storage medium as claimed in claim 1, wherein the second layer stack comprises a metal layer (6) nearest to the substrate and a protective layer (7) most remote from the substrate.

3. An optical data storage medium as claimed in claim 2, wherein the metal layer comprises one of aluminum, an aluminum alloy, silver and a silver alloy.

4. An optical data storage medium as claimed in claim 2, wherein the protective layer is spin coated.

5. An optical data storage medium as claimed in claim 4, wherein the protective layer is a UV-cured acrylate.

6. An optical data storage medium as claimed in claim 1, wherein the medium is one of a read only Blu-Ray Disc (BD), a write-once BD and a rewritable BD.

7. An optical data storage medium as claimed in claim 1, wherein the resinous substrate comprises one of polycarbonate (PC) and poly(methyl methacrylate) (PMMA).

8. A combi-foil suitable for roll-to-roll production comprising a polymer foil, in particular polycarbonate (PC), and a pressure sensitive adhesive (PSA) layer attached to one side of the polymer foil characterized in that the surface of the other side of the polymer foil has a relatively low surface energy in order to allow sufficient, i.e easy and smooth, release of the PSA when rolled out.

9. An optical data storage medium comprising at least:
a synthetic resinous substrate, having a first side and a second opposite side,
a first layer stack comprising: a data storage layer stack formed on the first side of the substrate, a transparent cover stack formed on the data storage layer stack, the data storage layer stack being readable through the cover stack by means of a focused radiation beam, characterized in that
the transparent cover stack comprises a combi foil as claimed in claim 8.
